(19) United States
(12) Patent Application Publication
(10) Pub. No.: US 2021/0037999 A1
(43) Pub. Date: Feb. 11, 2021

(54) A DRINKING STRAW AND A METHOD FOR MANUFACTURING IT

(71) Applicant: Dolea Oy, Helsinki (FI)

(72) Inventors: Mika Salomäki, Hyvinkää (FI); Eija Elonen, Düsseldorf (DE)

(73) Assignee: Dolea Oy, Helsinki (FI)

(21) Appl. No.: 16/979,810

(22) PCT Filed: Mar. 2, 2019
(86) PCT No.: PCT/FI2019/050170

§ 371 Date: Sep. 10, 2020

(30) Foreign Application Priority Data
Mar. 12, 2018 (FI) 20185225
Sep. 27, 2018 (FI) 20185809

(51) Int. Cl. A47G 21/18; B31D 5/00

(52) U.S. Cl. CPC A47G 21/18; B31D 5/0095

(57) ABSTRACT

The object of the invention is a drinking straw, which comprises a liquid channel (3) and one edge section (4), which liquid channel (3) is essentially parallel with the edge section (4). The drinking straw (1) material is sustainable, recyclable and biodegradable coated. cardboard, and in that the drinking straw (1) is formed of one essentially rectangular sheet-like piece (2) of the coated cardboard.

The object of the present invention is a disposable drinking straw as defined in the preamble of claim 1 and a method as defined in the preamble of claim 9 for manufacturing the drinking straw.

The drinking straw according to the invention and also the method for making it, which are hereinafter referred to as the solution according to the invention, is an environmentally friendly, sustainable solution for a drinking straw, to be easily manufactured from renewable and fully compostable, recyclable and tepuipable materials for the food service industry.

Nowadays with disposable drinking straws for beverages, when served for cold drinks, like juice drink, milk, cold coffee or tea drink, milkshake or smoothie or alcohol containing drinks are very often used with a plastic straw. After use, this disposable straw can easily be thrown into the nature as very small and light article, without being collected in the garbage bin, as disposable cups are used as on-the-go. Currently the European Commission proposes rules to the single-use plastic products most often as litter on Europe's beaches and seas, where plastic straw is one. According to these new rules, plastic straws will be banned in the whole EU region. Simultaneously several global companies have pledged to get rid of plastics straws from their offering to the market. Straws are also made of so-called bio-plastic. Bio-plastic is made of non-fossil renewable plant-based material. It is still plastic, because it contains polymers and it is not easy to recycle and is will not degrade to the nature. These PLA products will Stay in nature and marine environment for many years.

Plastic, when littered, is a loss not only in the economic value of the material, simultaneously it causes the costs of tidying up beaches, parks or other parts of nature and causes negative impact for tourism, fisheries and shipping. When in nature, plastics grade extremely slowly. They accumulate in rivers, seas and beaches and plastic residues effect marine flora and fauna, plants as well as birds, sea turtles, seals, fish, whales and other sea animals and effect to our food chain at the end.

Another problem is that plastic and bioplastic recyclability is challenging, especially how to get collected to the right material stream. Often consumer throw used cup & straw into the same bin, even they are not same material. If used with paper cup, plastic or bio-plastic straw cannot be recycled in same method as a plastic straw. Plastic or bio-plastic straw alone should be recycled in the plastic stream, which is the least effective in recycling and straw represent a very small quantity in mass in the whole waste. According to the research of the plastic litter cleaned from the sea shore, from all the plastics waste, plastic straws and plastics cups were in the top 10 mostly found plastic waste.

Another type of disposable drinking straw is a paper straw. Paper straws have become a strong alternative to plastic straws, since they are more eco-friendly option. Some manufacturers are offering degradable paper straws. However, the problem with paper straws is slow and more expensive manufacturing process when spinning the paper to the shape of the drinking straw. Paper straw also comprises adhesive (glue) layer between the paper layer. This adhesive layer contains also polymers and thus paper straw is not plastic free product.

Another new type of drinking straw is a composite straw. Small wood articles have been mixed to resin forming the straw and it is manufactured with extrusion method like manufacturing of plastic straws. Resin in the composite straw is made basically plastic (PLA) comprising polymers.

Yet another disadvantage of all today's drinking straw is a very limited and not optimal shape printing area on side of the straw. The drinking straw would be a perfect place for commercial advertisements, product information, logos, funny pictures to children, etc. Plastic-, bio-plastic—and composite straws are made of extrusion techniques and free printing is not possible. Some limited printing can be done to paper straws, but because of the winding technology, the printings are mainly colored strips or recurring figure-wide printable surface is missing.

The purpose of the present invention is to eliminate the aforementioned drawbacks and to provide an inexpensive, simple and environmentally-friendly solution for disposable drinking straws from renewable recyclable fiber material or other effectively recyclable material or biodegradable material.

The object of the present invention is to eliminate drawbacks of prior art technology and to introduce new type of a disposable drinking straw, and a method to manufacturing it. The base material of drinking straw preferably glazed board or coated board. The cardboard may also be coated on the other side with thin coating, which enable cardboard fastening to each other by sealing. The material of the drinking straw according the invention can be biodegradable, and/or the material can be easily recyclable and repulpable.

One object of the invention is to introduce a drinking straw, which comprises a liquid channel and one edge section, which liquid channel is essentially parallel with the edge section. The drinking straw material is sustainable, recyclable and biodegradable coated cardboard, and in that the drinking straw is formed of one essentially rectangular sheet-like piece of the coated cardboard.

The drinking straw according to the invention is characterized by what is disclosed in the characterization part of claim 1 and the method for manufacturing the drinking straw is characterized by what is disclosed in the characterization part of claim 9. Other embodiments of the invention are characterized by what is disclosed in the other claims.

An advantage of the invention is that it is a better designed drinking straw product for recycling, which allows when collected with paper cups a unified material stream for the recycling schemes. The drinking straw material can also be biodegradable material and repulpable fibre-based material. The drinking straw according to the invention is environment-friendly sustainable drinking straw. When the drinking straw is formed by heat-sealing, it comprises no additional components, like adhesives/glues, thus it is made of plain coated cardboard. Since the straw does not contain additional component it is also safe to use.

Another advantage of the invention is simple and fast manufacturing methods of drinking straws comparing for example to the methods in manufacturing paper straws. The cost of manufactured drinking straws according to invention is very low, cheaper than with the traditional paper straws.

Yet another advantage and use of the invention is, that the drinking straw outlook can be personalized with printings. The coated cardboard material is feasible for free printing and the surface area of the drinking straw is large and especially in drop-shape straws it is two sided, which may contain various multicolor printings. Printings may be, for example: advertising, logos, text, product information, seasonal themes, etc. Also, wide surface of the drinking straw enables the use of several add-on functions in the drinking straw, like: color changing thermometer, appearing figures, different sensors (e.g. toxic sensor, alcohol sensor, etc.), measuring line for liquids, etc. The printing inks is selected to be food certified inks.

In the following, the invention will be described in greater detail by the aid of some embodiments and by referring to the attached simplified drawings, wherein

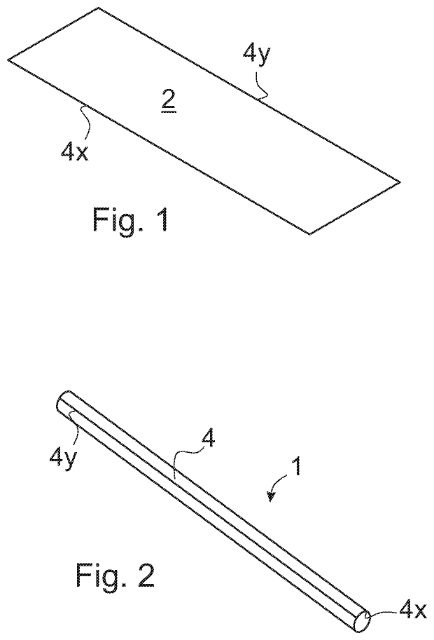

FIG. 1 presents a shapeable sheet-like rectangular piece, from which the drinking straw is formed of, as viewed obliquely from above and from the side,

FIG. 2 presents a shapeable rectangular sheet-like piece in FIG. 1 bended to form of a round drinking straw, as viewed obliquely from above and from the side,

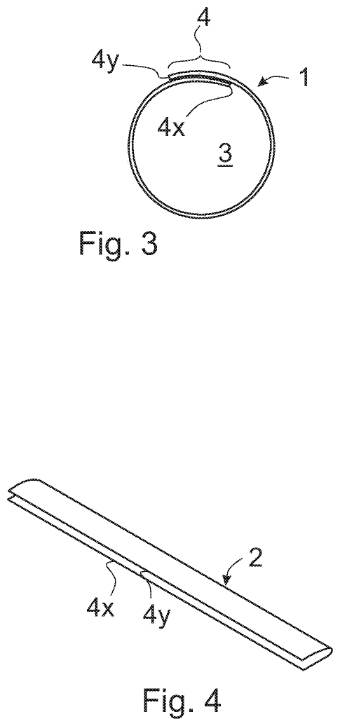

FIG. 3 presents a top view of the cross-sectioned drinking straw in FIG. 2,

FIG. 4 presents a rectangular shapeable sheet-like piece in FIG. 1 bended to form a flat, or drop-shape drinking straw, as viewed obliquely from above and from the side,

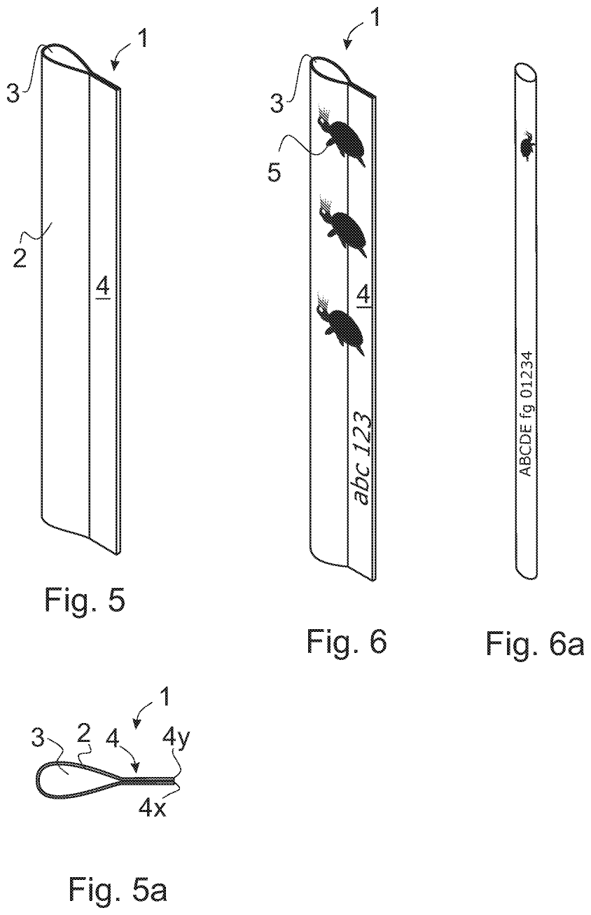

FIG. 5 presents an embodiment of a drinking straw with one edge section and the drinking straw is formed from one sheet-like piece, as viewed obliquely from above and from the side,

FIG. 5a presents a top view of the cross-sectioned drinking straw in FIG. 5,

FIG. 6 presents the drinking straw in FIG. 5 with printings on its surface, as viewed obliquely from above and from the side,

FIG. 6a presets the drinking straw in FIG. 2 with printings on its surface, as viewed obliquely from above and from the side,

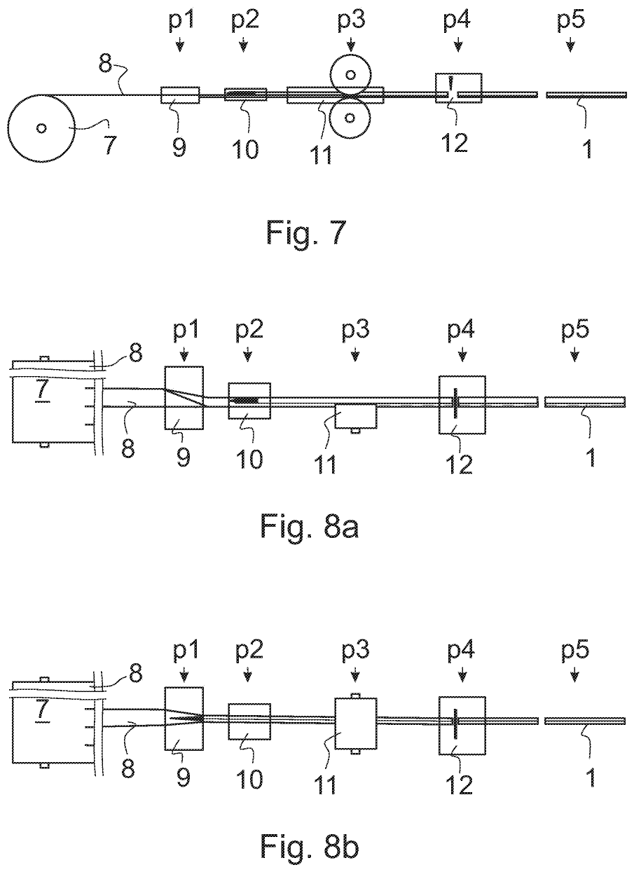

FIG. 7 presents the side view of a manufacturing process of the drinking straw in FIG. 2 and in FIG. 5,

FIG. 8a presents the top view of a manufacturing process of the drinking straw in FIG. 5, and

FIG. 8b presents the top view of a manufacturing process of the drinking straw in FIG. 2.

FIG. 1 presents an essentially rectangular shapeable sheet-like piece 2, from which the drinking straw 1 is formed, as viewed obliquely from above and from the side. This sheet-like piece 2 is cut preferably from a coated cardboard web in the fabrication phase described later. The sheet-like piece 2 comprises opposite edges 4x and 4y.

The coated cardboard used in this drinking straw embodiment is sustainable environment-friendly cardboard utilized also e.g. in paper cups. This coated cardboard coating is made online with cardboard manufacturing process using dispersion techniques. The coating layer is very thin comprising much less plastic than e.g. conventional PE-/PLA coated card boards. This material is easy to recycle with other paper-products and the material is repulpable. This coated cardboard id also biodegradable and degrade in marine environment easily. This coated cardboard is also heat-sealable providing the drinking straw manufacturing without additional components, like adhesives or glues.

In FIG. 2 is presented the shapeable sheet-like piece 2 in FIG. 1 bended to form of a round drinking straw 1, as viewed obliquely from above and from the side. The sheet-like piece 2 is bended so, the opposite edges 4x and 4y are overlapped and meets each other and are joined together. In FIG. 3 is presented a top view of the cross-sectioned the round drinking straw in FIG. 2.

The round drinking straw 1 is formed of one essentially rectangular sheet-like piece 2 and it comprises one edge section 4 and a liquid channel 3. The edge section 4 is alongside or adjacent and essentially parallel with the liquid channel 3. The edge section 4 is also essentially straight. The sheet-like piece 2 is bended so, the opposite edges 4x and 4y are overlapped. In the overlapped cardboard sections, the same side of the sheet-like piece 2 surfaces are facing each other's. The overlapped cardboard sections are fastened tightly together forming the edge section 4. When the edge section 4 is formed, also the liquid channel 3 is formed alongside and essentially parallel to the edge section 4. Comparing to prior art drinking straw technologies, extrusion-based straws (plastic, bioplastic and composite) don't have edge section at all and the edge section in the paper straw is not parallel or straight with the liquid channel, since the edge section traverse spirally in the straw.

In FIG. 4 is presented the essentially rectangular shapeable sheet-like piece in FIG. 1 bended to form a flat, or drop-shape drinking straw, as viewed obliquely from above and from the side.

In FIG. 5 is presented an embodiment of a drinking straw 1 with one edge section 4 and the drinking straw 1 is formed from one rectangular sheet-like piece 2, as viewed obliquely from above and from the side. In FIG. 5a is presented a top view of the cross-sectioned drinking straw 1 in FIG. 5.

The drinking straw 1 is formed of one essentially rectangular sheet-like piece 2 and it comprises one edge section 4 and a liquid channel 3. The sectioned drinking straw 1 is drop shaped. The edge section 4 is alongside or adjacent and essentially parallel with the liquid channel 3. The edge section 4 is also essentially straight. The sheet-like piece 2 is bended so, the opposite edges 4x and 4y are overlapped and meets each other. The overlapped cardboard sections are fastened tightly to each other forming the edge section 4. In the overlapped cardboard sections, the same side of the sheet-like piece 2 surfaces are facing each other's. It is also possible to flip the other edge so, that opposite side surfaces are facing each other's. When the edge section 4 is formed, also the liquid channel 3 is formed alongside and essentially parallel to the edge section 4.

In FIG. 6 is presented the drinking straw 1 in FIG. 5 with printings 5 on its surface, as viewed obliquely from above and from the side and in FIG. 6a is presented the drinking straw in FIG. 2 with printings on its surface, as viewed obliquely from above and from the side,

The drinking straw 1 according to this innovation has a coated cardboard surface, which provides good surface for printings 5. In relatively large printing surface, it is possible to design various printing themes. The drop shaped drinking straw 1 has two printable sides. With printings 5, the drinking straws 1 can be personalized. The printing 5 may contain various multicolor printings. Printings 5 may be, for example: advertising, logos, text, product information, seasonal themes, etc.

In FIG. 7 is presented a side view of a manufacturing process of the drinking straw 1 of FIG. 2 and in FIG. 5 with a production machine. In FIG. 8a is presented a top view of a manufacturing process of the drop-shaped drinking straw of FIG. 5 with a production machine. In FIG. 8a is presented a top view of a manufacturing process of the round drinking straw of FIG. 1 with a production machine.

The drinking straw 1 coated cardboard material, which is e.g. preprinted, is rolled out from the material roll 7. The out-rolled material forms a continuous web 8. In a phase p1, the web 8 is bent with a bending means 9 in a shape of the drinking straw. In a phase p2, the liquid channel is formed with a mold means 10. In phase a p3, the overlapped edges 4x and 4y of the web 8 are fastened to each other with a fastening means 11 forming the edge section 4 of the drinking straw 1. When the edge section 4 is formed, also the liquid channel 3 is formed alongside or adjacent and essentially parallel to the edge section 4. In phase a p4 the web is cut to the desired length of the drinking straws 1. In a phase p5, the drinking straw 1 is manufactured.

It is obvious, the original material rolls 7 presented above and in pictures are wider than a single web 8. The material roll 7 is cut to several parallel webs 8 to parallelly produce the drinking straws 1. It is also possible to cut the material roll 7 in desired width of the web 8 in advance, e.g. with preprinting process.

Advantageously, the material of the drinking straws 1 presented above used in drinking straws is coated cardboard which is sustainable, biodegradable, easily recyclable and repulpable material.

When at least other side of the sheet-like piece 2 is coated and the sheet-like piece 2 is bended or folded with thin plastic coating layers facing each other, the fastening of the edge section 4 of the drinking straws 1 can be made by heat or cold sealing. When there is no sealable coating on the material, the fastening of the edge section 4 of the drinking straws 1 can made by food-contact approved adhesives. The heat sealing fastening method provides drinking straws 1 without additional components, like adhesives or glues.

To avoid the waterlogging of the drinking straw 1 material, the raw edges of the material (cut edges) may be treaded with hydrophobic coating or corresponding. The waterlogging can also be reduced by cutting the material edges in skew angle and press the material flat in manufacturing phase.

In the embodiments presented above, it is advantageous to form the round or the flat/drop shaped drinking straw 1, which feels good in a user's mouth. The drinking straw 1 dimensions depend on the beverage viscosity and on the user target group—babies, children, adults. For juices and children beverages, advantageously the straw 1 has smaller dimensions. For example, the straw thickness is less than 5.0 mm and the straw width is between 12 mm and 22 mm. For adult beverages and higher viscosity beverages, advantageously the drinking straw 1 thickness, is less than 9.0 mm and the width is between 15 mm and 25 mm.

It is obvious to the person skilled in the art that different embodiments of the invention are not limited to the example described above, but that they may be varied within the scope of the claims presented below. What is essential is that the disposable drinking straw according to the invention is an environmentally-friendly and easily recyclable or biodegradable drinking straw. Thus, for example, the shapes and dimensions of the drinking straw can be different to what is described in the embodiments. The sectioned shape of the drinking straw may be for example round, ellipse or drop shape.

It is also obvious to the person skilled in the art that the drinking straw according to the invention can also be made from another sustainable material than mentioned in the embodiments.

1. A drinking straw, made of biodegradable material, which drinking straw (1) comprises a liquid channel (3) and one edge section (4), which liquid channel (3) is essentially parallel with the edge section (4), characterized in that the drinking straw (1) material is sustainable and recyclable heat sealable coated cardboard, and in that the drinking straw (1) is formed of one essentially rectangular sheet-like piece (2) of the coated cardboard and that the drinking straw (1) comprises a heat sealed fastening and which material edge is pressed flat in manufacturing phase.

2. The drinking straw according to claim 1, characterized in that the edge section (4) comprises two overlapping layers of material, which are fastened to each other.

3. The drinking straw according to claim 1, characterized in that the drinking straw (1) two overlapping material layers of the edge section (4) have been fastened to each other by heat sealing thin sealable coatings of the coated cardboard together.

4. The drinking straw according to claim 1, characterized in that a sectioned shape of the drinking straw (1) is round or ellipse or drop-shape.

5. The drinking straw according to claim 1, characterized in that the drinking straw (1) comprises a printable surface for printings (5).

6. The drinking straw according to claim 1, characterized in that the drinking straw (1) comprises large and uniform, whole drinking straw (1) covering printable surface for printings (5).

7. The drinking straw according to claim 1, characterized in that whole surface of the sheet-like piece (2) forming outer surface of the drinking straw (1) is pre-printable before drinking straw (1) forming process.

8. A method for manufacturing a drinking straw made of biodegradable material, which drinking straw (1) comprises a liquid channel (3) and one edge section (4), which liquid channel (3) is alongside and essentially parallel with the edge section (4), characterized in that the drinking straw (1) is fabricated from one essentially rectangular sheet-like sustainable and recyclable piece of heat sealable coated cardboard (2) with a production machine and that the drinking straw (1) is formed by heat sealing and which material edge is pressed flat in manufacturing phase.

9. The method according to claim 8, characterized in that the drinking straw (1) is fabricated from one shapeable sheet-like piece (2), which is bended without sharp fold so, that the two opposite edges (4x, 4y) of the sheet-like piece (2) are overlapped and overlapped sections are fastened to each other forming one drinking straw (1) edge section (4) and the liquid channel (3) is formed alongside and essentially parallel with the edge section (4).

10. The method according to claim 8, characterized in that in the material for the drinking straws (1) is rolled out from one or more material rolls (7), preferably as pre-printed with printings (5).

11. The method according to claim 8, characterized in that in the fabricating process the material for the drinking straws (1) is rolled out as a web (8) from the material roll (7), which web (8) is formed and fastened to a shape of the drinking straw (1) and the formed web (8) is cut to a desired length of the drinking straws (1).

12. The method according to claim 8, characterized in that the production machine comprises several parallel webs (8), which are rolled out from several parallel material rolls (7) to produce parallelly the drinking straws

13. The method according to claim 8, characterized in that the drinking straw (1) edge section (4) is formed by fastening the shapeable sheet-like piece (2) overlapped material layers by heat sealing.

14. The method according to claim 8, characterized in that the drinking straw (1) raw cut edges are treated with hydrophobic coating.
